(19) United States
(12) Patent Application Publication
(10) Pub. No.: US 2011/0267290 A1
(43) Pub. Date: Nov. 3, 2011

(54) TOUCH SCREEN PANEL AND IMAGE DISPLAY DEVICE HAVING THE SAME

(75) Inventors: Jung-Mok PARK, Yongin-City (KR); Sung-Ku Kang, Yongin-City (KR); Choon-Hyop Lee, Yongin-City (KR)

(73) Assignee: Samsung Mobile Display Co., Ltd., Yongin-city (KR)

(21) Appl. No.: 12/953,795

(22) Filed: Nov. 24, 2010

(30) Foreign Application Priority Data
Apr. 28, 2010 (KR) 10-2010-0039540

(51) Int. Cl. G06F 3/041

(52) U.S. Cl. 345/173

(57) ABSTRACT

A touch screen panel having a simple structure, the touch screen panel including: a transparent substrate having a touch active region, and a touch inactive region disposed at an edge portion of the touch active region; sensing patterns formed in the touch active region of the transparent substrate, the sensing patterns including: first sensing cells connected in a first direction by first connecting patterns and second sensing cells connected in a second direction by second connecting patterns; a black matrix formed in the touch inactive region of the transparent substrate; a first insulating layer disposed between the first connecting patterns and the second connecting patterns at locations where the first connecting patterns intersect with the second connecting patterns, and a second insulating layer formed to cover the black matrix in the touch inactive region, in which the first insulating layer and the second insulating layer are made of a same material in a same layer.

### CROSS-REFERENCE TO RELATED APPLICATIONS

This application claims the benefit of Korean Patent Application No. 10-2010-0039540, filed Apr. 28, 2010, in the Korean Intellectual Property Office, the disclosure of which is incorporated herein by reference.

### BACKGROUND

1. Field

Aspects of the present invention relate to a touch screen panel and an image display device having the same, and more particularly, to a touch screen panel having a simple structure and an image display device having the same.

2. Description of the Related Art

A touch screen panel is an input device to select contents displayed on a screen of an image display device using a person's hand or an object to input commands of a user. To this end, the touch screen panel is disposed on a front face of the image display device. The touch screen panel converts a point of contact of a person's hand or an object into electrical signals. Accordingly, the instruction selected by the person's hand or the object at the contact point is received as an input signal. The touch screen panel can replace a separate input device that is operated by being connected with the image display device such as a keyboard and a mouse. Thus, use of the touch screen panel is being expanded gradually.

The touch screen panel recognizes a touch at the contact point as an input signal through a conductive sensing cell in the screen region of the touch screen panel displaying the image. In other words, when the image display device includes the touch screen panel, the screen region is a touch active region that receives the touch input as well as a display region displaying the image. Meanwhile, an edge portion of the screen region is a region having wirings, such as signal lines, power lines, and the like. The wirings connect to the display region and the touch active region. The edge portion is a touch inactive region and may be a black matrix region preventing a visibility of the wirings as well as a touch inactive region.

To this end, a window substrate disposed in an uppermost portion of the image display device is formed with a black matrix to corresponded with the black matrix region. Generally the touch screen panel includes a transparent substrate that is formed with the conductive sensing cells, and related elements. A window substrate is disposed in an upper portion of the touch screen panel, in addition to the display panel for displaying the image. Therefore, the structure of the image display device is relatively complex and a disadvantage of an increased thickness of the touch screen panel exists.

### SUMMARY

Aspects of the present invention provide a touch screen panel having a simple structure, and an image display device having the same.

According to aspects of the present invention, there is provided the touch screen panel including a transparent substrate having a touch active region, and a touch inactive region disposed at an edge portion of the touch active region; sensing patterns formed in the touch active region of the transparent substrate, the sensing patterns including first sensing cells connected in a first direction by first connecting patterns and second sensing cells connected in a second direction by second connecting patterns; a black matrix formed in the touch inactive region of the transparent substrate; and a first insulating layer disposed between the first connecting patterns and the second connecting patterns at locations where the first connecting patterns intersect with the second connecting patterns, and a second insulating layer formed to cover the black matrix in the touch inactive region, in which the first insulating layer and the second insulating layer are made of a same material in a same layer.

According to another aspect of the present invention, the first insulating layer and the second insulating layer are formed one body on a side of the transparent substrate having the touch active region and the touch inactive region.

According to another aspect of the present invention, the first insulating layer is disposed between the first sensing cells, the second sensing cells, and the second connecting patterns, wherein the first sensing cells, the second sensing cells, and the second connecting patterns are disposed in a layer different from a layer having the first connecting patterns, wherein the first insulating layer is formed in the touch active region, and wherein the first insulating layer may include contact holes electrically connecting the first connecting patterns to the first sensing cells.

According to another aspect of the present invention, the second sensing cells and the second connecting patterns are formed as one body.

According to another aspect of the present invention, the first sensing cells, the second sensing cells, and the second connecting patterns are made of a same material in a same layer.

According to another aspect of the present invention, the first connecting patterns are formed in the touch active region and the black matrix is formed in the touch inactive region on a same side of the transparent substrate, wherein the first insulating layer and the second insulating layer are formed to be one body in an upper portion of the transparent substrate having the first connecting patterns and the black matrix, wherein the first sensing cells, the second sensing cells, and the second connecting patterns are formed on the first insulating layer, and wherein the first connecting patterns are connected to the first sensing cells by the contact holes penetrating the first insulating layer.

According to another aspect of the present invention, the first sensing cells, the second sensing cells, and the second connecting patterns are formed in the touch active region on a same side of the transparent substrate, wherein the black matrix is formed in the touch inactive region on the same side of the transparent substrate, wherein the first insulating layer and the second insulating layer are formed to be one body in the upper portion of the transparent substrate having the first sensing cells, wherein the first connecting patterns are formed on the first insulating layer, and wherein the first connecting patterns are electrically connected to the first sensing cells by the contact holes penetrating the first insulating layer.

According to another aspect of the present invention, the first insulating layer is formed only at the intersection location of the first connecting patterns and the second connecting patterns.

According to another aspect of the present invention, the first connecting patterns are formed in the touch active region and the black matrix is formed in the touch inactive region, wherein the first connecting patterns and the black matrix are formed on a same side of the transparent substrate, wherein the first insulating layer is formed on the first connecting patterns in order to expose a region of the first connecting patterns, wherein the first sensing cells are formed in the touch active region, wherein the first sensing cells are connected to the first connecting patterns through the exposed region of the first connecting patterns, wherein the second sensing cells are formed in the touch active region between the first sensing cells, and wherein the second sensing cells and the second connecting patterns are formed to be one body via the upper portion of the first insulating layer.

According to another aspect of the present invention, the first sensing cells, the second sensing cells, and the second connecting patterns are formed in the touch active region on a same side of the transparent substrate, wherein the black matrix is formed in the touch inactive region on the same side of the transparent substrate, wherein the first insulating layer is formed on the second connecting patterns, and wherein the first connecting patterns are connected to the first sensing cells via an upper portion of the first insulating layer.

According to another aspect of the present invention, the first insulating layer and the second insulating layer are made of an acryl-based organic layer, a polyimide-based organic layer, a silicone nitride layer, or a silicone oxide layer.

According to another aspect of the present invention, the transparent substrate is a window substrate disposed in an uppermost portion among substrates included in the image display device, and wherein the black matrix, the first insulating layer, the second insulating layer, the first sensing cells, the second sensing cells, the first connecting patterns and the second connecting patterns are formed in a bottom side of the transparent substrate opposing a touch side of the transparent substrate.

According to aspects of the present invention, an image display device includes a display panel displaying an image; and a touch screen panel receiving a touch input disposed in an upper portion of the display panel, the touch screen panel including: a transparent substrate having a touch active region, and a touch inactive region disposed at an edge portion of the touch active region; sensing patterns formed in the touch active region, the sensing patterns having first sensing cells connected in a first direction by first connecting patterns and second sensing cells connected in a second direction by second connecting patterns; a black matrix formed in the touch inactive region; and a first insulating layer disposed between the first connecting patterns and the second connecting patterns at locations where the first connecting patterns intersect with the second connecting patterns, and a second insulating layer formed to cover the black matrix in the touch inactive region, in which the first insulating layer and the second insulating layer are insulating layers made of a same material in a same layer.

According to another aspect of the present invention, the transparent substrate of the touch screen panel is a window substrate to be contacted by a contact object performing a touch input, and wherein the window substrate is disposed in an uppermost portion of the touch screen panel.

According to aspects of the present invention, the sensing patterns that are formed in the touch active region, and the black matrix formed in the touch inactive region along the edge portion of the touch active region are formed on a same transparent substrate. The sensing patterns include the first and the second sensing cells connected in the first and the second directions, respectively, by the first and the second connecting patterns. The first insulating layer is disposed between the first and the second connecting patterns to insulate them from each other, and the second insulating layer is formed to cover the black matrix. The first and second insulating layers are formed during a same manufacturing process.

In other words, according to aspects of the present invention, the sensing patterns and the black matrix are formed in a same transparent substrate. Also, the first insulating layer, which insulates the sensing cells connected in the different directions from each other, and the second insulating layer, which covers the black matrix are made of a same material in a same layer. To this end, the structures of the touch screen panel and the image display device having the touch screen panel can be simplified, and the methods of manufacturing the display device can be simplified, and also, a thickness of the display device and the touch screen panel can be reduced.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a plan view showing a touch screen panel according to an embodiment of the present invention;

FIG. 2 is an enlarged view showing a principle part of sensing patterns according to an embodiment of the present invention;

FIGS. 3A and 3B are cross-sectional views showing a touch screen panel having sensing patterns depicted in FIG. 2;

FIG. 4 is an enlarged view showing a principle part of sensing patterns according to another embodiment of the present invention;

FIGS. 5A and 5B are cross-sectional views showing a touch screen panel having sensing patterns depicted in FIG. 4;

FIG. 6 is an enlarged view showing a principle part of sensing patterns according to another embodiment of the present invention;

FIGS. 7A and 7B are cross-sectional views showing a touch screen panel having sensing patterns depicted in FIG. 6;

FIG. 8 is an enlarged view showing a principle part of sensing patterns according to another embodiment of the present invention; and

FIGS. 9A and 9B are cross-sectional views showing a touch screen panel having sensing patterns depicted in FIG. 8.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

As referred to herein, when a first element, item or layer is said to be disposed or formed “on”, or “adjacent to”, a second element, item or layer, the first element, item or layer can directly contact the second element, item or layer, or can be separated from the second element, item or layer by one or more other elements, items or layers located therebetween. In contrast, when an element, item or layer is referred to as being disposed or formed “directly on” another element, item or layer, there are no intervening elements, items or layers present.

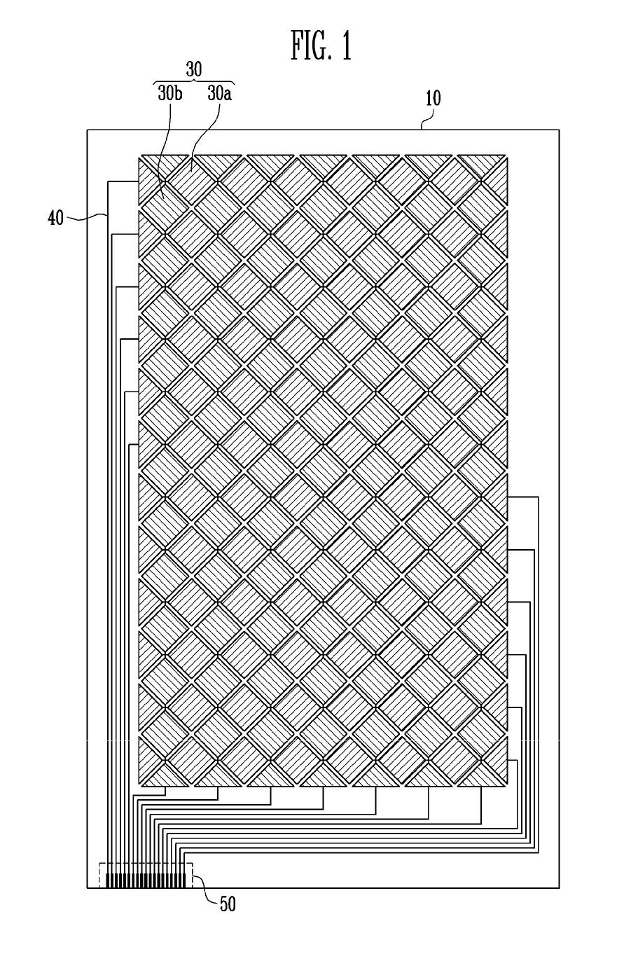

FIG. 1 is a plan view showing a touch screen panel according to an embodiment of the present invention.

Referring to FIG. 1, a touch screen panel according to an embodiment of the present invention includes a transparent substrate 10, sensing patterns 30 formed on the transparent substrate 10, and position detecting lines 40 connecting the sensing patterns 30 to an external driving circuit through a pad unit 50.

The transparent substrate 10 is made of a transparent substrate material, such as a glass, a polyethylene terephthalate (PET), an acryl. However, aspects of the present invention are not limited thereto, and the transparent substrate 10 may be made of other suitable materials. According to aspects of the present invention, the expression “transparent” refers a high light transmission rate as well as 100% transparency. The transparent substrate 10 includes a touch active region having the sensing patterns 30, and a touch inactive region that is disposed in an edge portion of the touch active region and is formed with the position detecting lines 40, the pad unit 50, and the like.

The sensing patterns 30 are formed in the touch active region on one side of the transparent substrate 10. The sensing patterns 30 include first sensing cells 30a connected along a first direction and second sensing cells 30b connected along a second direction. The first sensing cells 30a and the second sensing cells 30b are made of a transparent electrode material, such as indium-tin-oxide (ITO). However, aspects of the present invention are not limited thereto, and the first sensing cells 30a and the second sensing cells 30b may be formed of other suitable materials.

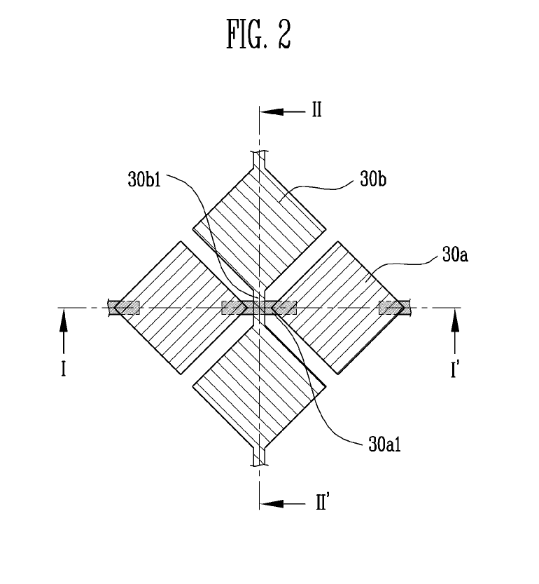

In addition, the sensing patterns 30 includes first connecting patterns 30a1 (see FIG. 2) connecting the first sensing cells along a first direction and second connecting patterns 30b1 (see FIG. 2) connecting the second sensing cells 30b along a second direction. The first sensing cells 30a are connected in the first direction, i.e., in a row direction, thereby respectively connecting to each position detecting line 40 in the rows. The second sensing cells 30b are connected in the second direction, which intersects with the first direction, i.e., in a column direction, between the first sensing cells 30a, thereby respectively connecting to each position detecting line 40 in the columns. In other words, the sensing patterns 30, according to the present embodiment, include the sensing cells 30a, 30b formed in the touch active region to receive a touch input, and the connecting patterns connecting the same.

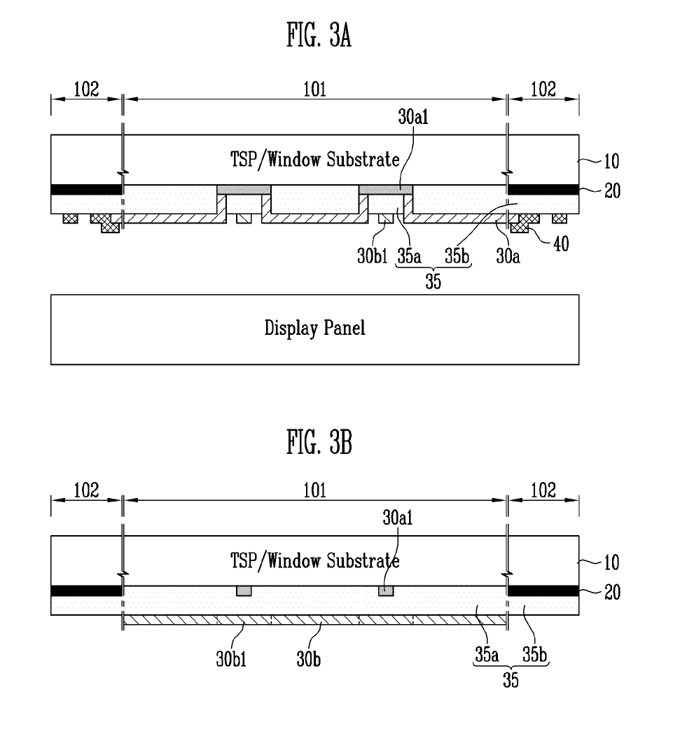

The first connecting patterns 30a1 and the second connecting patterns 30b1 (see FIG. 2) are disposed in a same layer, but include an insulating layer 35 (see FIG. 3) disposed between them in order to insulate them from each other. Alternatively, the first sensing cells 30a and the second sensing cells 30b may include the insulating layer 35 therebetween. In such a case, the first sensing cells 30a and the second sensing cells 30b are disposed in different layers from each other.

The position detecting lines 40 connect the sensing patterns 30 to an external driving circuit (not shown), such as a position detecting circuit through the pad unit 50. The position detecting lines 40 are disposed in the touch inactive region of the edge portion of the touch screen panel and are not disposed in the touch active region displaying the image. The position detecting lines 40 are formed of a low-resistance material, such as Mo, Ag, Ti, Cu, Ti, Mo/Al/Mo, or other suitable materials. Alternatively, the position detecting lines 40 may be formed of the transparent electrode materials used to form the sensing cells 30a, 30b.

The touch screen panel, as described above, is a capacitive touch screen panel. When the person's hand, stylus pen, and the like contact the capacitive touch screen panel, a change of electrostatic capacitance at the contact position is transmitted from the sensing patterns 30 to the external driving circuit to the pad unit 50 through the position detecting lines 40. Then, the contact position is converted from the change of the electrostatic capacitance into an electric signal through an X and Y input processing circuit (not shown), or other similar circuits or devices.

Although not shown in FIG. 1, the transparent substrate 10 having the sensing patterns 30 further includes a black matrix 20 (see FIG. 3A) that prevents visibility of patterns of the position detecting lines 40. The black matrix 20 also forms a black edge in the touch screen panel by being formed in the touch inactive region so as to be overlapped with the position detecting lines 40.

In other words, according to the present embodiment, the sensing patterns 30 and the black matrix 20 are formed in a same transparent substrate 10. The insulating layer 35, which insulates the first sensing cells 30a from the second sensing cells 30b also reduces a step, or change in height, resulting from the black matrix 20 by covering the black matrix. Additionally, the sensing patterns 30, the insulating layer 35 and the black matrix 20 are formed in a same layer during a same manufacturing operation by using a same material. Thus, according to aspects of the present invention, the touch screen panel and the image display device have a simple structure, and a simple manufacturing process, as well as a reduced thickness.

FIG. 2 is an enlarged view showing a principle part of the sensing patterns 30 according to an embodiment of the present invention, and FIGS. 3A and 3B are cross-sectional views showing a touch screen panel having the sensing patterns 30 depicted in FIG. 2. Referring to FIG. 2, the sensing patterns 30, according to the present embodiment, include the first and the second sensing cells 30a, 30b, and the first and the second connecting patterns 30a1, 30b1.

The first sensing cells 30a are each patterned to be an independent shape and are connected in the first direction by the first connecting patterns 30a1. The first connecting patterns 30a1 are made of a same transparent electrode material as that of the first sensing cells 30a, or are made of a low-resistance opaque electrode material. When the first connecting patterns 30a1 are made of the opaque electrode material, visibility of the first connecting patterns 30a1 is prevented by controlling a width, length, thickness, or other similar aspects of the first connecting patterns 30a1.

The second sensing cells 30b are integrally formed (i.e., formed to be one body or unit) with the second connecting patterns 30b1, and are patterned to be connected in the second direction. In this case, the insulating layer 35 (see FIG. 3A) is disposed between the first connecting patterns 30a1 and the second connecting patterns 30b1. The insulating layer 35 is disposed at a portion of the first connecting patterns 30a1 that intersects with the second connecting patterns 30b1 in order to insulate the first sensing cells 30a from the second sensing cells 30b.

In other words, the first connecting patterns 30a1 and the second connecting patterns 30b1 have the insulating layer 35 disposed between them and the first connecting patterns 30a1 and the second connecting patterns 30b1 are respectively disposed in different layers. For example, the first connecting patterns 30a1 are formed in a bottom portion of the insulating layer 35. The first sensing cells 30a, the second sensing cells 30b, and the second connecting patterns 30b1 are disposed in an upper portion of the insulating layer 35. The first connecting patterns 30a1 are electrically connected to the first sensing cells 30a by a contact hole (not shown) penetrating the insulating layer 35.

Hereinafter, the touch screen panel having the sensing patterns 30, as depicted in FIG. 2, will be described in more detail with reference to the cross-sectional views of FIGS. 3A and 3B. FIG. 3A is a cross-sectional view taken along line I-I′ of FIG. 2, and FIG. 3B is a cross-sectional view taken along line II-II′ of FIG. 2. Referring to FIGS. 3A and 3B, the transparent substrate 10 includes a touch active region 101 and a touch inactive region 102 disposed along the edge portion of the touch active region 101.

The touch active region 101 includes the sensing patterns 30, including the first and the second sensing cells 30a, 30b, and the first and the second connecting patterns 30a1, 30b1. The touch inactive region 102 of the transparent substrate 10 includes the black matrix 20 in a side of the transparent substrate 10 having the sensing patterns. In other words, the sensing patterns and the black matrix 20 are formed in the same side of the same transparent substrate 10.

When the sensing patterns 30 and the black matrix 20 are formed on the same transparent substrate 10, the transparent substrate 10 is a window substrate disposed in the uppermost portion of substrates included in the image display device. In other words, the touch screen panel, according to the present embodiment, is implemented as the touch screen panel having the window substrate.

In this case, the sensing patterns 30, including the first and the second sensing cells 30a, 30b and the first and the second connecting patterns 30a1, 30b1, and the black matrix 20 are formed on a bottom side of the transparent substrate 10. Also, a first and a second insulating layer 35a, 35b, which are disposed between the first and second connecting patterns 30a1, 30b1, or in an upper portion of the connecting patterns, are also formed in the bottom side of the transparent substrate 10. The transparent substrate 10 is opposite the touch side of the transparent substrate 10.

The first connecting patterns 30a1 and the second connecting patterns 30b1 include the first insulating layer 35a disposed between them to be insulated each other. The second insulating layer 35b, reducing a surface step, or difference in height caused by the black matrix 20, is formed in an upper portion of the black matrix 20. In other words, the first insulating layer 35a is formed in the touch active region 101, and is disposed between the first connecting patterns 30a1 and the second connecting patterns 30b1 at the intersection portion thereof. The second insulating layer 35b is formed in the touch inactive region 102 to cover the black matrix 20.

A structure of the touch screen panel, according to the present embodiment, will be described in more detail. The first connecting patterns 30a1 and the black matrix 20 are respectively formed in the touch active region 101 and the touch inactive region 102 on the same side of the transparent substrate 10 and are disposed in the same layer. In this case, the black matrix 20 is formed after forming the first connecting patterns 30a1. Alternatively, the first connecting patterns 30a1 may be formed after forming the black matrix 20, so that aspects and features of the black matrix 20 can be freely modified and performed during a forming of the black matrix 20. The first insulating layer 35a is formed only in the touch active region 101. The second insulating layer 35b is formed only in the touch inactive region 102.

However, the first insulating layer 35a and the second insulating layer 35b, according to the present embodiment, are insulating layers that are formed in a same layer during a same manufacturing operation by using a same material. Specifically, the first insulating layer 35a and the second insulating layer 35b are integrally formed, or in other words, formed to be one body or unit. Also, the first insulating layer 35a and the second insulating layer 35b are formed only in the upper portion of transparent substrate 10 having the first connecting patterns 30a1 and the black matrix 20. In other words, the first insulating layer 35a and the second insulating layer 35b are one insulating layer 35 that is integrally formed in one side of the transparent substrate 10.

The first insulating layer 35a and the second insulating layer 35b, which are part of the unified insulating layer 35, are made of an acryl-based organic layer, a polyimide-based organic layer, a silicone nitride layer (SiNx), or a silicone oxide layer (SiO2). However, aspects of the present invention are not limited thereto and the first insulating layer 35a and the second insulating layer 35b may be formed of other suitable materials.

The first sensing cells 30a, the second sensing cells 30b, and the second connecting patterns 30b1 are formed on the first insulating layer 35a of the touch active region 101. In other words, the first insulating layer 35a is disposed between the first connecting patterns 30a1 and the first sensing cells 30a, the second sensing cells 30b, and the second connecting patterns 30b1. Thus the first sensing cells 30a, the second sensing cells 30b, and the second connecting patterns are disposed in the different layer from the first connecting patterns 30a1.

The first sensing cells 30a, the second sensing cells 30b, and the second connecting patterns 30b1 are formed by using a same material in a same layer during a same manufacturing operation. In this case, the first sensing cells 30a are electrically connected to the first connecting patterns 30a1 by respective contact holes penetrating the first insulating layer 35a. In other words, the contact holes are formed in the first insulating layer 35a to electrically connect the first connecting patterns 30a1 to the first sensing cells 30a. The second sensing cells 30b and the second connecting patterns 30b1 are formed to connect each other in one body, or in other words, are integrally formed.

As depicted in FIG. 3A, the position detecting lines 40 are further formed in the touch inactive region 102.

The position detecting lines 40 are electrically connected to the first and the second sensing cells 30a, 30b by directly contacting with the first and the second sensing cells 30a, 30b in the upper or bottom portion of the first and the second sensing cells 30a, 30b. Alternatively, the position detecting lines 40 are connected to the first and the second sensing cells 30a, 30b through the contact holes. However, aspects of the present invention are not limited thereto, and the position detecting lines 40 may be electrically connected to the first and the second sensing cells 30a, 30b in other suitable manners. Therefore, cross-sectional views, except for FIG. 3A do not show the position detecting lines 40.

In addition, a display panel is disposed in a bottom portion of the touch screen panel according to the present embodiment, and a pixel region of the display panel overlaps with the touch active region 101 of the touch screen panel. In other words, the image display device, having the touch screen panel, includes the display panel displaying the image, and the touch screen panel, which is disposed in the upper portion of the display panel and receives the touch input.

Specifically, the touch screen panel, according to the present embodiment, can be implemented as the touch screen panel having the window, and the transparent substrate 10 as the substrate of the touch screen panel is the window substrate. The contact object for the touch input directly contacts the window substrate which is disposed in the uppermost portion of the image display device, except a case of the edge portion of the image display device.

Therefore, in the image display device having the touch screen panel having the window, according to the present embodiment, there are advantages that a thickness of the image display device is small and the cost of manufacturing the image display device is reduced because a separate window substrate is not needed for the image display device.

According to the touch screen panel of the present embodiment, the sensing patterns 30 and the black matrix 20 are formed in the same transparent substrate 10. Also the first insulating layer 35a insulating the sensing cells 30a, 30b, and the second insulating layer 35b covering the black matrix 20 are made of a same material in a same layer. More specifically, the sensing patterns 30, including the first and the second connecting patterns 30a1, 30b1 and the first and the second sensing cells 30a, 30b, and the black matrix 20 are formed in the same transparent substrate 10. Also, the first insulating layer 35a insulating the first and the second connecting patterns 30a1, 30b1 from each other, and the second insulating layer 35b covering the black matrix 20 are formed during a same manufacturing process.

In other words, according to aspects of the present invention, the second insulating layer 35b reducing the surface step of the black matrix 20 is formed at a same time as the first insulating layer 35a insulating between the first and the second sensing cells 30a, 30b. To this end, structures of the touch screen panel and the image display device having the touch screen panel can be simple, and the methods of manufacturing the touch screen panel and the image display device having the touch screen panel can be simple, and also, their thickness can be reduced.

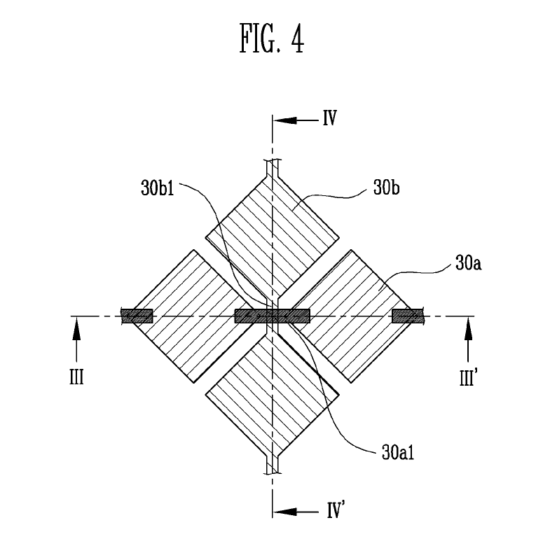

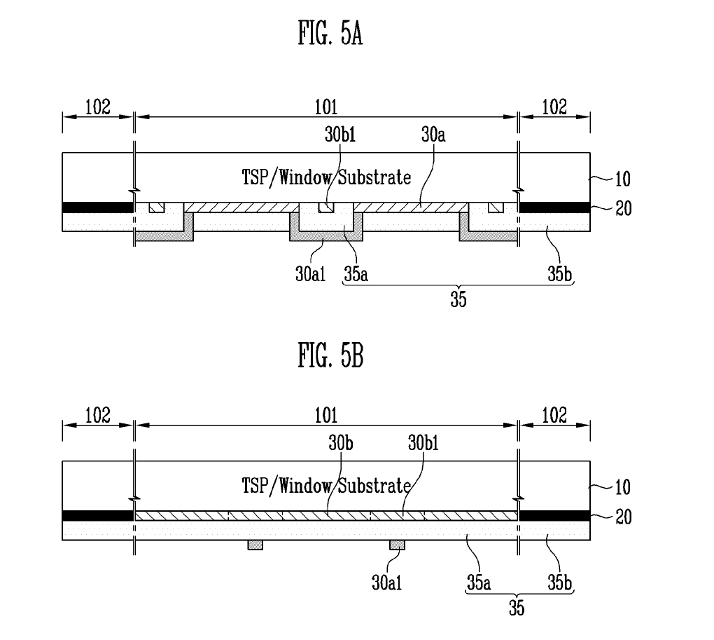

FIG. 4 is an enlarged view showing a principle part of sensing patterns 30 according to another embodiment of the present invention, and FIGS. 5A and 5B are cross-sectional views showing a touch screen panel having the sensing patterns 30 depicted in FIG. 4. FIG. 5A is a cross-sectional view taken along line III-III′ of FIG. 4 and FIG. 5B is a cross-sectional view taken along line IV-IV′ of FIG. 4. In FIG. 4 and FIG. 5, same or similar components or elements as those in FIG. 2 and FIG. 3 are indicated by same reference numerals, and a detailed description thereof is not provided.

Referring to FIG. 4 and FIG. 5, the first sensing cells 30a, the second sensing cells 30b, and the second connecting patterns 30b1 are disposed in a same layer as the black matrix 20, and the first connecting patterns 30a1 are disposed on the first insulating layer 35a. More specifically, the first sensing cells 30a, the second sensing cells 30b, and the second connecting patterns 30b1 are formed in the touch active region 101 on a same side of the transparent substrate 10, and the black matrix 20 is disposed in the touch inactive region 102 of the transparent substrate 10.

The first insulating layer 35a and the second insulating layer 35b are integrally formed to be one body, which is the insulating layer 35. The insulating layer 35 is disposed in the upper portion of the transparent substrate 10 having the first sensing cells 30a, the second sensing cells 30b, the second connecting patterns 30b1, and the black matrix 20.

The first connecting patterns 30a1 are formed on the insulating layer 35 in the touch active region 101. In other words, the first connecting patterns 30a1 are formed on the first insulating layer 35a of the insulating layer 35. The first connecting patterns 30a1 are electrically connected to the first sensing cells 30a through respective ones the contact holes penetrating the first insulating layer 35a.

FIGS. 2-FIG. 5, the first insulating layer 35a and the second insulating layer 35b are formed as one insulating layer 35. However, aspects of the present invention are not be limited thereto and the first insulating layer 35a and the second insulating layer 35b may be formed to not be the insulating layer 35 as one body, or in other words, the first insulating layer 35a and the second insulating layer 35b may be independently formed. For example, the first insulating layer 35a may be formed locally at the intersection portion of the first connecting patterns 30a1 and the second connecting patterns 30b1.

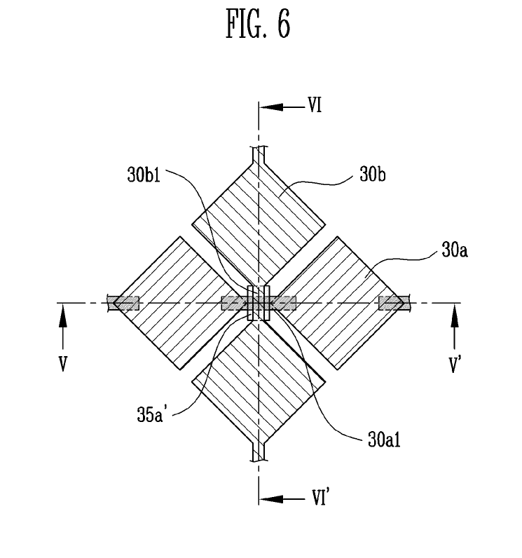

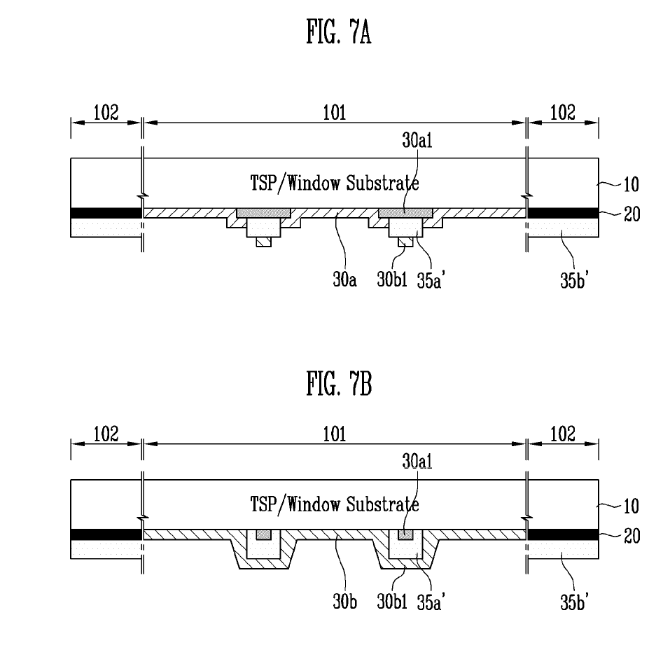

FIG. 6 is an enlarged view showing a principle part of sensing patterns 30 according to another embodiment of the present invention, and FIGS. 7A and 7B are cross-sectional views showing a touch screen panel having the sensing patterns 30 depicted in FIG. 6. FIG. 7A, illustrates a cross-sectional view taken along line V-V′ of FIG. 6, and FIG. 7B illustrates a cross-sectional view taken along line VI-VI′ of FIG. 6.

Referring to FIG. 6 and FIGS. 7A and 7B, the first insulating layer 35a′ is locally formed at the intersection portion of the first connecting patterns 30a1 and the second connecting patterns 30b1. The first connecting patterns 30a1 and the second connecting patterns 30b1 are disposed on opposite sides of the first insulating layer 35a′. More specifically, the first connecting patterns 30a1 are formed in the touch active region 101 and the black matrix 20 is formed in the touch inactive region 102. The first connecting patterns 30a1 and the black matrix 20 are formed on a same side of the transparent substrate 10.

The first insulating layer 35a′ is formed on the first connecting patterns 30a1 so as to expose a region of the first connecting patterns 30a1. The first sensing cells 30a are formed in the touch active region 101 having the first insulating layer 35a′ and are connected to the first connecting patterns 30a1 through the exposed region of the first connecting patterns 30a1. The second sensing cells 30b are formed in the touch active region 101 between the first sensing cells 30a. The second sensing cells 30b are formed as one body with the second connecting patterns 30b1 via an upper portion of the first insulating layer 35a′.

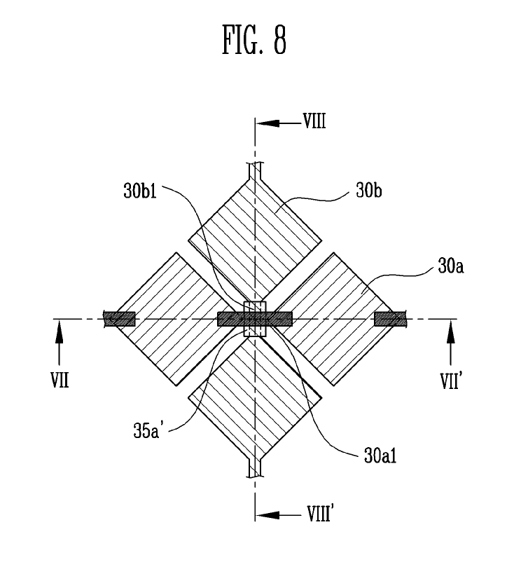

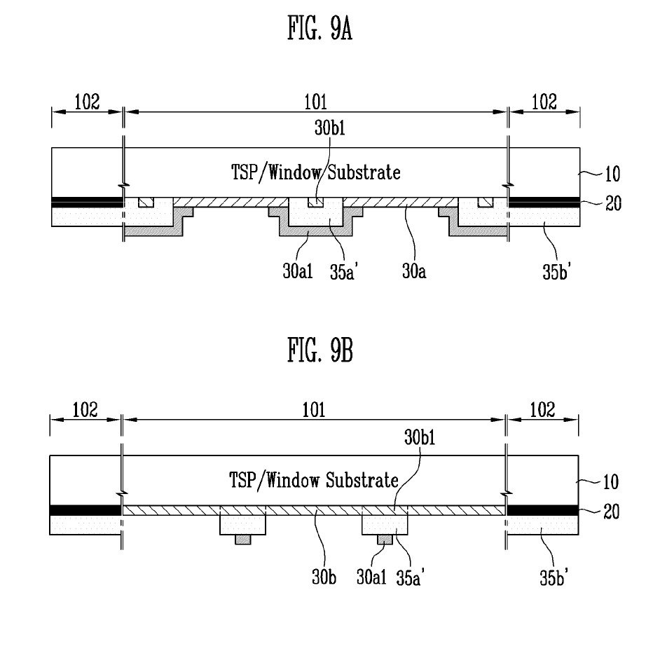

FIG. 8 is an enlarged view showing a principle part of sensing patterns 30 according to another embodiment of the present invention, and FIGS. 9A and 9B are cross-sectional views showing a touch screen panel having the sensing patterns 30 depicted in FIG. 8. FIG. 9A illustrates a cross-sectional view taken along line VII-VII′ of FIG. 8, and FIG. 9B illustrates a cross-sectional view taken along line VIII-VIII′ of FIG. 8.

Referring to FIG. 8 and FIG. 9, the first sensing cells 30a, the second sensing cells 30b, and the second connecting patterns 30b1 are formed in the touch active region 101 on one side of the transparent substrate 10. The black matrix 20 is formed in the touch inactive region 102 of the transparent substrate 10. In this case, the second sensing cells 30b are patterned to be connected with the second connecting patterns 30b1 as one body or unit, or in other words, the second sensing cells 30b and the second connecting patterns 30b1 are integrally formed together.

The first insulating layer 35a′ is formed on the second connecting patterns 30b1. The first connecting patterns 30a1 are connected to the first sensing cells 30a via an upper portion of the first insulating layer 35a′ so as to insulate the first connecting patterns 30a1 from the second connecting patterns 30b1. According to aspects of the present invention, the embodiments as depicted in FIG. 4 to FIG. 9 have advantages, such as structures of the touch screen panel and the image display device having the same can be simple. Additionally, methods of manufacturing the touch screen panel and the image display device having the same can be simplified, and furthermore a thickness of the touch screen panel and the image display device can be reduced, as compared to the embodiments as depicted in FIG. 2. and FIG. 3.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A touch screen panel comprising:
a transparent substrate comprising:
a touch active region; and
a touch inactive region disposed at an edge portion of the touch active region;
sensing patterns formed in the touch active region of the transparent substrate, the sensing patterns comprising:
first sensing cells connected in a first direction by first connecting patterns; and
second sensing cells connected in a second direction by second connecting patterns;
a black matrix formed in the touch inactive region of the transparent substrate;
a first insulating layer disposed between the first connecting patterns and the second connecting patterns at locations where the first connecting patterns intersect with the second connecting patterns; and
a second insulating layer formed to cover the black matrix in the touch inactive region,
wherein the first insulating layer and the second insulating layer are made of a same material in a same layer.

2. The touch screen panel as claimed in claim 1, wherein the first insulating layer and the second insulating layer are formed to be one body on a side of the transparent substrate having the touch active region and the touch inactive region.

3. The touch screen panel as claimed in claim 1, wherein the first insulating layer is disposed between the first sensing cells, the second sensing cells, and the second connecting patterns,
wherein the first sensing cells, the second sensing cells, and the second connecting patterns are disposed in a layer different from a layer having the first connecting patterns,
wherein the first insulating layer is formed in the touch active region, and
wherein the first insulating layer includes contact holes electrically connecting the first connecting patterns to the first sensing cells.

4. The touch screen panel as claimed in claim 3, wherein the second sensing cells and the second connecting patterns are formed as one body.

5. The touch screen panel as claimed in claim 3, wherein the first sensing cells, the second sensing cells, and the second connecting patterns are made of a same material in a same layer.

6. The touch screen panel as claimed in claim 1, wherein the first connecting patterns are formed in the touch active region and the black matrix is formed in the touch inactive region on a same side of the transparent substrate,
wherein the first insulating layer and the second insulating layer are formed to be one body in an upper portion of the transparent substrate having the first connecting patterns and the black matrix,
wherein the first sensing cells, the second sensing cells, and the second connecting patterns are formed on the first insulating layer, and
wherein the first connecting patterns are connected to the first sensing cells by the contact holes penetrating the first insulating layer.

7. The touch screen panel as claimed in claim 1, wherein the first sensing cells, the second sensing cells, and the second connecting patterns are formed in the touch active region on a same side of the transparent substrate,
wherein the black matrix is formed in the touch inactive region on the same side of the transparent substrate,
wherein the first insulating layer and the second insulating layer are formed to be one body in the upper portion of the transparent substrate having the first sensing cells,
wherein the first connecting patterns are formed on the first insulating layer, and
wherein the first connecting patterns are electrically connected to the first sensing cells by the contact holes penetrating the first insulating layer.

8. The touch screen panel as claimed in claim 1, wherein the first insulating layer is formed only at the intersection location of the first connecting patterns and the second connecting patterns.

9. The touch screen panel as claimed in claim 1, wherein the first connecting patterns are formed in the touch active region and the black matrix is formed in the touch inactive region,
wherein the first connecting patterns and the black matrix are formed on a same side of the transparent substrate,
wherein the first insulating layer is formed on the first connecting patterns in order to expose a region of the first connecting patterns,
wherein the first sensing cells are formed in the touch active region,
wherein the first sensing cells are connected to the first connecting patterns through the exposed region of the first connecting patterns,
wherein the second sensing cells are formed in the touch active region between the first sensing cells, and
wherein the second sensing cells and the second connecting patterns are formed to be one body via the upper portion of the first insulating layer.

10. The touch screen panel as claimed in claim 1, wherein the first sensing cells, the second sensing cells, and the second connecting patterns are formed in the touch active region on a same side of the transparent substrate,
wherein the black matrix is formed in the touch inactive region on the same side of the transparent substrate,
wherein the first insulating layer is formed on the second connecting patterns, and
wherein the first connecting patterns are connected to the first sensing cells via an upper portion of the first insulating layer.

11. The touch screen panel as claimed in claim 10, wherein the second sensing cells and the second connecting patterns are formed to be one body.

12. The touch screen panel as claimed in claim 1, wherein the first insulating layer and the second insulating layer are made of an acryl-based organic layer, a polyimide-based organic layer, a silicone nitride layer, or a silicone oxide layer.

13. The touch screen panel as claimed in claim 1, wherein the transparent substrate is a window substrate disposed in an uppermost portion among substrates included in the image display device, and
wherein the black matrix, the first insulating layer, the second insulating layer, the first sensing cells, the second sensing cells, the first connecting patterns, and the second connecting patterns are formed in a bottom side of the transparent substrate opposing a touch side of the transparent substrate.

14. An image display device comprising:
a display panel displaying an image; and
a touch screen panel receiving a touch input and disposed in an upper portion of the display panel, the touch screen panel comprising:
a transparent substrate comprising:
a touch active region; and
a touch inactive region disposed at an edge portion of the touch active region;
sensing patterns formed in the touch active region, the sensing patterns comprising:
first sensing cells connected in a first direction by first connecting patterns; and
second sensing cells connected in a second direction by second connecting patterns;
a black matrix formed in the touch inactive region; and
a first insulating layer disposed between the first connecting patterns and the second connecting patterns at locations where the first connecting patterns intersect with the second connecting patterns, and
a second insulating layer formed to cover the black matrix in the touch inactive region,
wherein the first insulating layer and the second insulating layer are insulating layers made of a same material in a same layer.

15. The image display device as claimed in claim 14, wherein the transparent substrate of the touch screen panel is a window substrate to be contacted by a contact object performing a touch input, and
wherein the window substrate is disposed in an uppermost portion of the touch screen panel.

16. A touch screen panel comprising:
a transparent substrate having a touch active region and a touch inactive region disposed in an edge portion of the touch active region;
sensing patterns formed in the touch active region;
a black matrix formed in the touch inactive region;
a first insulating layer disposed on the sensing patterns; and
a second insulating layer disposed on the black matrix,
wherein the first insulating layer and the second insulating layer are made of a same material in a same layer.

17. The touch screen panel as claimed in claim 16, wherein the sensing patterns comprise:
first sensing cells connected along a first direction by first connecting patterns; and
second sensing cells connected along a second direction by second connecting patterns,
wherein the first insulating layer is disposed between the first connecting patterns and the second connecting patterns, and
wherein the first insulating layer is disposed where the first connecting patterns intersect the second connecting patterns.

18. The touch screen panel as claimed in claim 17, further comprising:
a pad unit connecting the touch screen panel to an external drive circuit; and
position detecting lines connecting the sensing patterns to the pad unit,
wherein the position detecting lines are connected to the first sensing patterns in the first direction and are connected to the second sensing patterns in the second direction.

19. The touch screen panel as claimed in claim 18, wherein the black matrix is formed over the position detecting lines.

20. The touch screen panel as claimed in claim 16, wherein the first insulating layer and the second insulating layer are formed to be one body on a side of the transparent substrate having the touch active region and the touch inactive region.
